(19) United States
(12) Patent Application Publication
(10) Pub. No.: US 2023/0249447 A1
(43) Pub. Date: Aug. 10, 2023

(54) METHOD AND DEVICE FOR COVERING BOXES

(71) Applicant: KOLBUS GMBH & CO. KG, Rahden (DE)

(72) Inventors: Heiko Landwehr, Barnstorf (DE); Leonid Ugorets, Bassum (DE); Nils Brokate, Kirchdorf (DE); Dominik Windhorst, Bielefeld (DE); Sandra Engelmeier, Rahden (DE)

(21) Appl. No.: 18/012,342

(22) PCT Filed: Jun. 1, 2021
(86) PCT No.: PCT/EP2021/064620

§ 371 Date: Dec. 22, 2022

(30) Foreign Application Priority Data
Jun. 25, 2020 (DE) 10 2020 116 844.6

(51) Int. Cl. B32B 37/10; B31B 50/74; B32B 37/00; B32B 37/12

(52) U.S. Cl. CPC B32B 37/10; B31B 50/74; B32B 37/0046; B32B 37/12; B31B 2120/50

(57) ABSTRACT

A box laminating machine with two rubbing-down devices that lie opposite of one another with respect to the box to be covered, wherein each rubbing-down device has a counter-holder that plunges into the box and a rubbing-down element that sweeps over the wall to be covered, which is supported against the counter-holder. The rubbing-down operation of opposing walls takes place successively, wherein a movement of the box relative to the counter-holder takes place perpendicular to the wall to be rubbed down.

### BACKGROUND

The present invention pertains to a method for covering boxes and to an apparatus for carrying out the method.

A system for producing boxes with an apparatus for covering the raw boxes is disclosed in publication US2009/0156380A1. In this system, the raw boxes and the cover material provided with glue, i.e., the sheet blanks, are fed from respective upstream apparatuses to a joining device by means of transport devices. This joining device places the bottom of the raw box on the glued side of the sheet blank. The sheet blank is rolled down on all four box walls in a downstream apparatus. Any protrusion of the sheet blank is turned inward. A covering device is assigned to each wall for this purpose.

The four covering devices are arranged opposite of one another in pairs. They respectively have a rubbing-down roller and a turn-in slide. Joining of the sheet on the outer walls takes place by rolling the rubbing-down rollers on the outer sides of the box. For this purpose, the box is vertically transported through between the stationary first pair of covering devices in a first step. The box subsequently remains in a resting position and the turn-in slides of the first pair turn the protrusions of the sheet blank inward. Subsequently, the second pair of covering devices rolls down the sheet on the remaining walls in a vertical movement of their rubbing-down rollers before their turn-in slides turn in the remaining protrusions. A form punch is subsequently lowered into the covered box in order to rub down the turned-in cover on the inner sides of the box.

Such a covering device allows a compact construction. However, one disadvantage can be seen in the resulting poor accessibility of the components. Cleaning of the elements that come in contact with the cover sheet particularly is impeded. Only one pair can process the box at all times due to the arrangement of the covering devices relative to one another. The other pair has to wait until this processing is completed or the box is transported out of the apparatus. The capacity of the system therefore remains limited. The form punch has to be manufactured extremely true to size in order to reliably glue the turn-ins of the sheet to the inner surfaces of the raw box on the one hand and to prevent damages to the box on the other hand. This requires a separate form punch for each inside dimension of a box to be produced. Format deviations of the raw boxes, e.g., due to manufacturing tolerances or climatic influences, also lead to corresponding quality losses of the finished boxes or even rejects.

### SUMMARY

An objective of the present invention therefore can be seen in developing an apparatus that is improved in comparison with the prior art, eliminates at least one of the aforementioned disadvantages of the prior art and meets the increased requirements regarding the product quality to be achieved.

The box laminating machine comprises different processing devices and transport devices. These processing devices are arranged on the transport paths of the transport devices. A transport system successively transports the respective blank box to be covered into different processing stations of the box laminating machine for processing. In this case, the transport of the blank box to be covered takes place in a plane extending parallel to the bottom of the blank box. However, the laminating machine at least comprises a transport device and two side roll-down devices.

These side roll-down devices are arranged opposite of one another with respect to the transport path of the blank boxes, designed in a mirror-inverted manner and form a pair. Consequently, their construction and function are described below with reference to only one of the at least two identical side roll-down devices.

The side roll-down device is arranged on the transport path of the transport device. It has at least one rubbing-down element and one counter-holder assigned to this rubbing-down element. The counter-holder plunges into the raw box. The rubbing-down element subsequently rubs down the corresponding wall region of the sheet blank on the associated wall of the raw box against the counter-holder. For this purpose, the rubbing-down element sweeps over the wall of the box in a rubbing-down movement. The force flow takes place from the rubbing-down element through the respective sheet to be joined and the associated wall of the blank box. In this context, it is irrelevant whether the rubbing-down element is formed by a rail, a brush or an optionally driven roller.

The apparatus has a first guidance system of the rubbing-down element, which defines the movement path of the rubbing-down element. A second guidance system of the counter-holder defines the movement path of the counter-holder. This movement path of the counter-holder comprises at least one segment that is oriented parallel to the transport path of the raw box. The rubbing-down operation during the continuing transport of the box allows a temporal overlap of movements such that an increased throughput can be achieved.

The two side roll-down devices lying opposite of one another act upon the same blank box successively in order to respectively rub down a region of the sheet. An optimal force flow through sheet and wall can be respectively achieved in that opposing walls of the box are covered successively. Quality losses resulting from format deviations of the individual blank boxes or even damages to the boxes are likewise prevented.

A movement of the counter-holder relative to the associated wall preferably takes place perpendicular to the wall. This ensures that the counter-holder plunges into the box in a contactless manner, but the sheet itself is two-dimensionally supported against the rubbing-down element during the rubbing-down operation. A very small movement in comparison with the dimensions of the boxes is already sufficient in this case. Such a transverse movement in both opposing rubbing-down devices is particularly advantageous. For this purpose, these rubbing-down devices are designed in a mirror-inverted manner to one another.

In a first advantageous embodiment, the counter-holder is mounted so as to be pivotable about an axis. This pivoting axis extends parallel to the respective wall to be covered. It lies above the boxes in such a way that the movement of the counter-holder in the region of the box wall extends approximately transverse to the transport direction of the boxes. In an alternative embodiment, the rubbing-down device comprises a linear guide extending transverse to the transport direction, wherein the counter-holder is guided in said linear guide.

A pivoting axis of the rubbing-down element is provided in another alternative embodiment. This pivoting axis extends parallel to the respective wall to be covered. The pivoting axis is spaced apart from the contact surface of the rubbing-down element in such a way that this contact surface experiences a significant partial movement perpendicular to the wall to be covered. In a fourth embodiment, the rubbing-down element is accommodated in a linear guide of the rubbing-down device. This linear guide is oriented perpendicular to the box wall to be covered.

This transverse movement preferably is generated by a controllable drive. This controllable drive exchanges signals with the control of the box laminating machine. In this way, the transverse movement can be optimized with respect to the materials used and the current machine speed.

The device preferably has defined end positions with respect to the movement perpendicular to the wall to be covered. In this way, the respective movement of the rubbing-down element and the counter-holder is reproducible and a constant quality can be ensured. A mechanical stop, which prevents a movement beyond the permissible range independently of potential malfunctions of the control, is particularly suitable for this purpose.

It is particularly advantageous that the rubbing-down operation takes place during a continuing transport movement. For this purpose, the counter-holder moves in the transport direction synchronous with the respective box as long as it is located within the box. The receptacle of the counter-holder has a guide extending in the transport direction and a corresponding drive. In addition, rubbing-down devices lying opposite of one another with respect to the transport path are arranged behind one another in the transport direction. In this way, the product transport is not unnecessarily interrupted. The products are treated with care due to lower and less frequent accelerations and an increased output can be achieved.

The counter-holder preferably experiences a revolving movement with a pronounced linear movement segment that extends parallel to the transport direction. In this way, the respective wall to be covered only experiences a movement relative to contacting components of the apparatus on its outer side during the rubbing-down operation.

### BRIEF DESCRIPTION OF THE DRAWINGS

An exemplary embodiment of the invention is described below with reference to the figures, to which we refer with respect to all details that are not mentioned in greater detail in the description. In these figures:

FIG. 1 shows a schematic representation of the product flow and the associated transport devices of an apparatus for covering boxes;

FIG. 2 shows a schematic representation of a side roll-down device;

FIG. 3 shows a counter-holder of a side roll-down device;

FIG. 4 shows a movement diagram of a side roll-down device; and

FIG. 5 shows a rubbing-down element of a side roll-down device.

### DETAILED DESCRIPTION

FIG. 1 schematically shows the product flow during a box covering operation. The raw boxes 2 are respectively made available in a standby position by an infeed 7. For this purpose, the box infeed 7 has a transport device with a first conveyor belt 31. The raw boxes 2 are moved into the standby position such that their bottom 21 points downward and is aligned horizontally. The end walls 22 of the raw box 2 are oriented parallel to the feed direction whereas the sidewalls 23 are oriented transverse to the feed direction. The feed direction extends transverse to the transport path 1000, on which the processing devices 100, 200 are arranged. The standby position of the raw boxes 2 is arranged adjacent to a band conveyor 30 of the sheet infeed 8 supplying the sheet blanks 1.

The sheet blanks 1 are glued individually, transferred to the band conveyor 30 and moved along a linear transport path 1000. Suitable apparatuses for applying glue on the sheet 1 are sufficiently known and therefore not illustrated in the figures or described in greater detail. A not-shown robot picks up the supplied raw box 2 and places it on the bottom region 11 of the cover sheet 1 in an accurately positioned manner in a curved downward movement 1010. The now connected unit 3 consisting of the raw box 2 and the sheet blank 1 glued to its bottom 21 is transferred to a conveyor device 9 that follows the band conveyor 30 and has the same transport direction 1000.

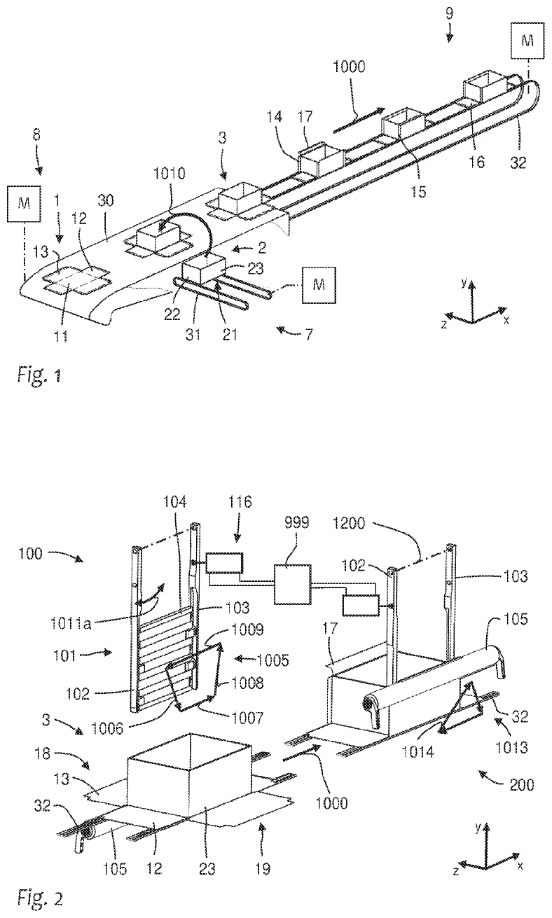

The conveyor belts 32 of this conveyor device 9 transport the box units 3 through the processing devices 100, 200 arranged along the transport path 1000 in order to completely cover the box units 3. The elements 101, 102, 103, 105 of a left side roll-down device 100 and a right side roll-down device 200 arranged opposite and downstream thereof, which interact with the box unit 3, are illustrated in FIG. 2. The side roll-down devices 100, 200 are designed in a mirror-inverted manner referred to the transport path. Consequently, only the left side roll-down device 100 is described below.

A first rubbing-down roller 105 of the left side roll-down device 100 is illustrated in its starting position underneath the movement path of the box units 3. The rubbing-down roller 105 is essentially cylindrical. Its rotational axis extends parallel to the transport direction 1000 of the box units 3. The rubbing-down roller 105 rolls on the sidewall 23 in a vertical partial movement 1004 from its starting position and in the process rolls down the associated outer region 13 of the sheet blank 1 on the sidewall 23.

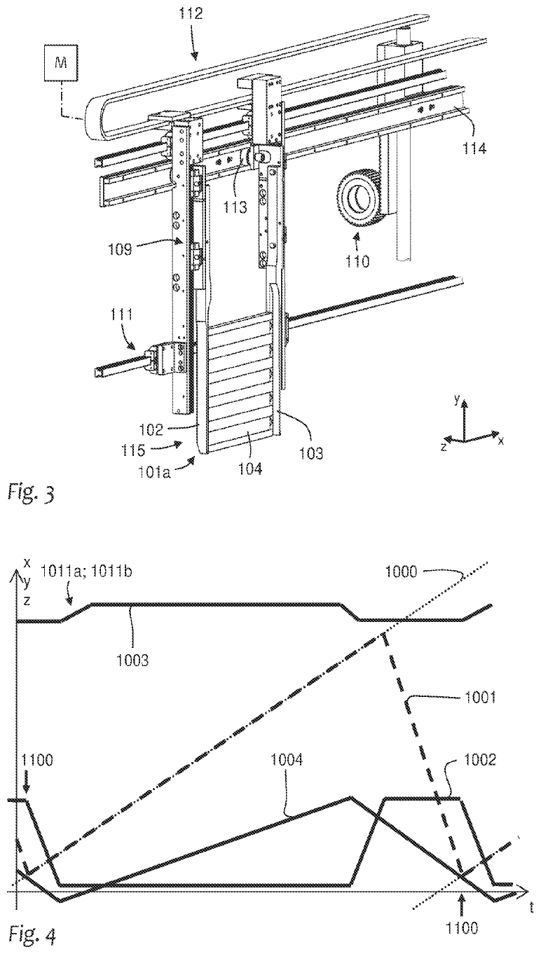

A counter-holder 101 is provided in order to support the sidewall 23 against the rubbing-down roller 105 during the roll-down operation. This counter-holder 101 is formed by a pair of punches 102, 103. A supporting plate 104 is arranged between the punches 102, 103 in order to realize a full-surface support. A supporting surface 115, which is illustrated in FIG. 3 and extends parallel to the associated box wall 23, is respectively formed by a pair of punches 102, 103 together with the corresponding supporting plate 104.

A revolving movement 1005 of the counter-holder 101 is realized by means of the linear guidance systems 109, 111 illustrated in FIG. 3. A horizontally oriented linear guide 111 is arranged parallel to the transport path 1000 of the box units 3. It accommodates a vertically aligned linear guide 109 in the manner of a coordinate table. The punches 102, 103 of the counter-holder 101 are accommodated in the vertical linear guide 109. The vertical guide 109 is connected to a drive 112 in such a way that it can be moved along the horizontal guide 111. The vertical partial movement 1002 of the counter-holder 101 is generated by another drive 110 that acts upon the punches 102, 103. This drive 110 for the vertical partial movement 1002 of the counter-holder 101 comprises a guide track 114 that can be vertically moved in a motor-driven manner. This guide track extends parallel to the transport direction 1000 of the box units 3. A roller 113 arranged on a punch 103 of the counter-holder runs in the guide track 114 in order to transmit its vertical movement 1002 to the counter-holder 101.

The counter-holder 101 plunges into the raw box 1 from its starting position 1100 above the box unit 3 during a closed, revolving movement 1005 on the sidewall 23 while the box 3 is continuously transported in the predefined direction 1000 by the belts 32. The revolving movement 1005 of the counter-holder 101 essentially takes place in a plane extending parallel to its supporting surface 115. In FIG. 2, this plane is defined by the transport path 1000 of the box units 3, which extends in a horizontal x-direction, and a vertical y-direction. The revolving movement 1005 is composed of multiple segments. The lowering segment 1006 into the box 3 begins in the starting position 1100 above the box unit 3 and ends within the box unit 3 at or slightly above its bottom 21. It can be dissected into a vertical portion 1002 and a simultaneous horizontal portion 1001. The lowering segment 1006 essentially is characterized by a vertical downward movement relative to the box. The lowering segment 1006 is followed by a holding segment 1007, during which the counter-holder 101 maintains a fixed position relative to the box unit 3. The counter-holder 101 moves synchronous with the box unit 3 in its transport direction 1000. The actual rubbing-down operation of an outer region 13 of the sheet blank 1 on the outer surface of the associated box wall 23 by means of the rubbing-down roller 105 takes place during this holding segment 1007. The subsequent lifting segment 1007 corresponds to the lowering segment 1006 with a reversed vertical partial movement 1002. The counter-holder 101 ultimately returns into its starting position 1100 in a horizontal return movement 1009.

FIG. 2 shows the pivoting axis 1200 of the counter-holder 101. The punches 102, 103 are mounted so as to be rotatable about this pivoting axis together with the corresponding supporting plate 104. The pivoting movement 1011a is realized by means of pneumatic cylinders 116 that are controlled by the box laminating machine.

The revolving movement 1013 of the rubbing-down element 105 is in a simplified manner characterized by three successive linear movement segments. The actual rubbing-down movement 1014 can be dissected into a portion running parallel to the transport direction 1000 and a vertical portion 1004.

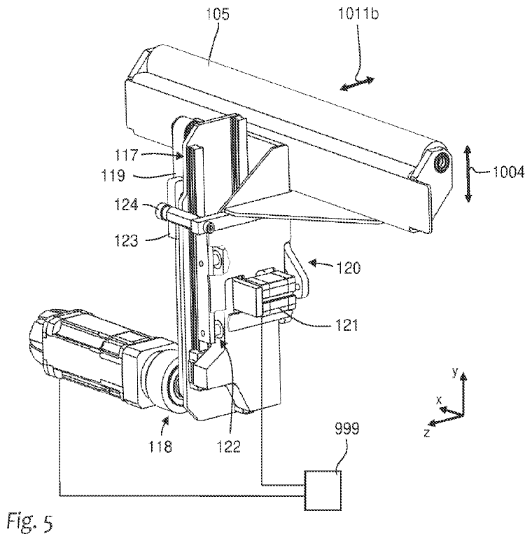

FIG. 5 shows the construction of the rubbing-down element that additionally carries out a linear movement 1011b transverse to the transport direction 1000 of the boxes 3. For this purpose, the rubbing-down roller 105 is accommodated in a compound table analogous to the counter-holder 101. This compound table comprises a vertically extending linear guide 117, the carriage of which carries a horizontal linear guide 122 extending perpendicular to the transport direction 1000.

A pneumatic cylinder 121 is provided for realizing the advance movement 1011b transverse to the transport direction 1000. The drive 118 for the vertical movement 1004 is realized in the form of an electric motor with a revolving toothed belt 119. In order to place the rubbing-down roller 105 against the box 3 in a particularly precise yet careful manner, its receptacle has a roller 124, which rolls on a curve 123 that essentially extends vertically and serves as a stop.

The utilization of the construction illustrated in FIG. 5 makes it possible to forgo the pivoting movement 1011a of the counter-holder 101, as well as the elements 116, 1200 required for this pivoting movement.

FIG. 4 shows the temporal correlations between the partial spatial movements 1000, 1001, 1002, 1004, 1011a, 1011b in accordance with the coordinate systems in the illustrations in FIGS. 1 to 3 and FIG. 5 in the form of a movement diagram. In this case, all movements 1000, 1001, 1002, 1004, 1011a, 1011b are illustrated in a simplified manner and composed of linear portions with different gradients. The transport movement 1000 of the box unit 3 is illustrated in the form of a dotted line. It extends in the form of an ascending straight line in the x-direction as a function of the time t.

The horizontal movement 1001 of the counter-holder 101 is illustrated with a broken line and divided into the holding segment 1007 and the return movement 1009. The progression of the horizontal movement 1001 is identical to the transport movement 1000 of the box units 3 during the holding segment 1007. The vertical partial movement 1002 of the counter-holder 101 is illustrated with a continuous line. The coinciding gradient jumps of the vertical partial movement 1002 and the horizontal partial movement 1001 of the counter-holder 101 characterize its starting position 1100. The holding segment 1007 is defined by the lower end position of the vertical movement 1002. FIG. 4 clearly shows that the segment of the horizontal movement 1001, which takes place synchronous with the transport movement 1000, comprises in terms of time the movement segments lowering 1006, holding 1007 and lifting 1008.

The vertical partial movement 1004 of the rubbing-down roller 105 is likewise illustrated with a continuous line. The rubbing-down operation takes place during the upward movement. This upward movement coincides with the holding segment 1007 of the counter-holder 101. The horizontal partial movement of the rubbing-down roller 105 ensures that a rolling movement on the box unit 3 only runs perpendicular to the bottom 21. A movement of the rubbing-down roller 105 relative to the box 3 in the direction extending parallel to the transport movement 1000 is prevented.

The movement 1011a of the counter-holder 101 perpendicular to the wall 23 to be covered and the alternative movement 1011b of the rubbing-down roller 105 perpendicular to the wall 23 to be covered are illustrated in the form of a common curve. It has a rest period 1003 during the actual rubbing-down operation 1004. The horizontal partial movement of the rubbing-down roller 105 in the transport direction 1000 is not illustrated. It is simply identical to the horizontal partial movement 1001 of the counter-holder.

The movement diagram in FIG. 4 shows the sequences of movement in a schematically simplified manner. Curved transitions may be chosen instead of the gradient jumps. This particularly makes it possible to advantageously influence the machine dynamics. In addition, the movement segments and partial movements shown may shift relative to one another or overlap. In this way, the loads occurring due to the machine dynamics can be additionally reduced and the processing times can be improved. These adaptations can be optimized in dependence on the dimensions of the boxes 2 or the sheet blanks 1.

According to the invention, the respective transverse movement 1011a, 1011b of the counter-holder 101 and the rubbing-down element 105 may also take place while the box 3 to be covered is at a standstill. In this case, it is possible to forgo the respective partial movements 1001 of the counter-holder 101 and the rubbing-down element 105 parallel to the transport direction 1000. The construction is simplified accordingly, but not illustrated in the figures.

### REFERENCE SYMBOLS

1 Sheet blank
2 Raw box
3 Partially covered box
4 Box, finished
5 Glue
7 Raw box infeed
8 Sheet infeed
9 Box transport
11 Bottom region
12 Outer region, end wall
13 Outer region, sidewall
14 Side flap, left
15 Side flap, right
16 Turn-in, end wall
17 Turn-in, sidewall
18 Adhesive side
19 Outer side
21 Bottom
22 End wall
23 Sidewall
30 Band conveyor
31 First conveyor belt, box infeed
32 Second conveyor belt, box covering
100 Side roll-down device, left sidewall
101 Counter-holder, left
101a Bevel, left counter-holder
102 Punch, left rear
103 Punch, left front
104 Supporting plate
105 Rubbing-down element, left
109 Linear guide, vertical (counter-holder)
110 Drive, vertical stroke (counter-holder)
111 Linear guide, horizontal (counter-holder)
112 Drive, horizontal stroke (counter-holder)
113 Roller (counter-holder)
114 Rail, optionally curve (counter-holder)
115 Supporting surface, counter-holder
116 Drive, application of counter-holder
117 Linear guide, vertical (rubbing-down element)
118 Drive, vertical stroke of rubbing-down element
119 Belt, vertical stroke of rubbing-down element
120 Carriage, rubbing-down element
121 Drive, application of rubbing-down element
122 Linear guide, transverse (rubbing-down element)
123 Curve, application of rubbing-down element
124 Curve roller, application of rubbing-down element
200 Side roll-down device, right sidewall
1000 Transport path, box
1001 Partial movement, counter-holder horizontal (x)
1002 Partial movement, counter-holder vertical (y)
1003 Partial movement, counter-holder transverse (z)
1004 Partial movement, rubbing-down element vertical (y)
1005 Revolving movement, counter-holder
1006 Lowering segment, counter-holder
1007 Holding segment, counter-holder
1008 Lifting segment, counter-holder
1009 Return movement, counter-holder
1010 Downward movement, raw box
1011a Transverse movement, counter-holder
1011b Transverse movement, rubbing-down element
1012 Separation, counter-holder
1013 Revolving movement, rubbing-down element
1014 Rubbing-down movement
1100 Starting position, counter-holder
1200 Pivoting axis, counter-holder

1-15. (canceled)

16. A method for covering boxes with a flexible sheet blank by means of adhesive joining in a box laminating machine, wherein:
a box to be covered have a plane bottom and multiple plane walls each having an outer joining surface, with said walls connected to the bottom and arranged orthogonal thereto;
the flexible sheet blank comprising a material sheet having a joining surface;
at least one outer joining surface of the bottom or walls of the box to be covered is adhesively joined with the joining surface of the flexible sheet blank;
the box laminating machine comprising multiple processing stations and the box to be covered successively passes through the multiple processing stations, wherein:
the box to be covered is transported between the multiple processing stations in a plane that extends parallel to the bottom of the box to be covered;
one of the multiple processing stations comprising a first rubbing down device including a first rubbing-down element and a first counter-holder corresponding to the first rubbing-down element,
the first counter-holder plunges into the box to be covered and comes into contact with an inner surface of a first wall to be covered;
the first rubbing-down element is moved over the outer joining surface of the first wall to be covered in a first rubbing down movement, wherein:
the first rubbing-down movement of the first rubbing down element begins adjacent to or at an edge of the already joined surface and the first rubbing-down element sweeps over the outer joining surface of the first wall to be covered during the first rubbing down movement,
the first rubbing-down movement of the first rubbing-down element takes place while the first counter-holder is in contact with the inner surface of the first wall to be covered, and
another of the multiple processing stations comprising at least one second rubbing-down device including a second rubbing-down element and a second counter-holder corresponding to the second rubbing-down element,
the second counter-holder plunges into the box to be covered and comes into contact with an inner surface of a second wall to be covered,
the second rubbing-down element is moved over the outer joining surface of the second wall to be covered in a second rubbing-down movement,
the second rubbing-down movement of the second rubbing-down element begins adjacent to or at an edge of the already joined surface and the first rubbing-down element sweeps over the outer joining surface of the second wall to be covered during the second rubbing-down movement,
wherein the second wall to be covered of the box to be covered is arranged opposite to the first wall to be covered of the same box to be covered and the at least one second rubbing-down movement of the second rubbing-down element takes place while the at least one second counter-holder corresponding to the second rubbing-down element is in contact with the inner surface of the second wall to be covered and the first rubbing-down movement of the first rubbing-down element is completed.

17. The method of claim 16, comprising at least one first relative movement between the first wall to be covered and the first counter-holder wherein the at least one first relative movement takes place perpendicular to the first wall to be covered while the first counter-holder at least partially plunges into the box to be covered.

18. The method of claim 17, comprising at least one second relative movement between the second wall to be covered and the at least one second counter-holder wherein the at least one second relative movement takes place perpendicular to the second wall to be covered while the second counter-holder at least partially plunges into the box to be covered.

19. The method of claim 16, comprising at least one first relative movement between the first wall to be covered and the first rubbing down element wherein the first relative movement takes place perpendicular to the first wall to be covered.

20. The method of claim 18, wherein the first or second relative movement is realized due to a movement of the first counter-holder or second counter-holder which runs perpendicular to the first or second wall to be covered.

21. The method of claim 16, wherein the first rubbing-down movement of the first rubbing-down element or the second rubbing-down movement of the second rubbing-down element takes place during a continuing transport movement of the box to be covered, which runs parallel to the bottom of the box to be covered.

22. The method of claim 17, wherein an amount of the at least one relative movement between the first wall to be covered and the first counter-holder is small in comparison with the first rubbing-down movement of the of the first rubbing-down element.

23. An apparatus for covering boxes with at least one flexible sheet blank by means of adhesive joining, wherein the boxes to be covered have a plane bottom and multiple plane walls, each having an outer joining surface, with said walls being connected to the bottom and arranged orthogonal thereto, the flexible sheet blank comprising a material sheet having a joining surface, the outer joining surface of the bottom or at least one wall of the box is adhesively joined with the joining surface of the flexible sheet blank, said apparatus comprising:
a transport device having a transport element that captures the boxes to be covered and moves them along a transport path extending parallel to the bottom of the box to be covered,
a first rubbing-down device arranged on the transport path and having a movable first rubbing-down element and a movable first counter-holder corresponding to the first rubbing-down element,
a first guidance system connected to the first rubbing-down element and a second guidance device connected to the first counter-holder, wherein the first guidance system defines a movement path of the first rubbing-down element and the second guidance system defines a movement path of the first counter-holder,
a second rubbing-down device arranged on the transport path and having a movable second rubbing-down element and a movable second counter-holder corresponding to the second rubbing-down element,
a third guidance system connected to the second rubbing-down element and a fourth guidance system connected to the second counter-holder, wherein the third guidance system defines a movement path of the second rubbing-down element and the fourth guidance system defines a movement path of the second counter-holder, and wherein the transport path is arranged between the first rubbing-down device and the second rubbing-down device.

24. The apparatus of claim 23, wherein the first or second counter-holder or the first or second rubbing-down element comprises a pivoting axis, wherein the pivoting axis is aligned parallel to the first or second wall to be covered.

25. The apparatus of claim 23, wherein the first or second counter-holder or the first or second rubbing-down element comprises a linear guide aligned perpendicular to the first or second wall to be covered.

26. The apparatus of claim 24, comprising a controllable drive connected to the first or second counter-holder or the first or second rubbing-down element, wherein an effective direction of said controllable drive extends approximately perpendicular to the first or second wall to be covered.

27. The apparatus of claim 26, comprising two end positions and one stationary or quasi-stationary holding position of the counter-holder or rubbing-down element connected to the controllable drive, wherein said holding position lies between the two end positions.

28. The apparatus of claim 27, comprising a stop of the counter-holder or rubbing-down element connected to the controllable drive, wherein said stop defines the stationary or quasi-stationary holding position.

29. The apparatus of claim 23, comprising a successive arrangement of the first rubbing-down device relative to the second rubbing-down device in the transport direction of the box to be covered.

30. The apparatus of claim 23, comprising a guidance system of the first counter-holder or second counter-holder, wherein said guidance system defines a movement path of the first counter-holder or second counter-holder, and wherein the movement path has a movement segment that is linear and oriented parallel to the transport path of the box to be covered.
